(19) United States
(12) Patent Application Publication
(10) Pub. No.: US 2021/0281156 A1
(43) Pub. Date: Sep. 9, 2021

(54) STEPPING MOTOR

(71) Applicant: AAC Microtech (Changzhou) Co., Ltd., Changzhou City (CN)

(72) Inventor: Suohe Wei, Shenzhen (CN)

(21) Appl. No.: 17/137,396

(22) Filed: Dec. 30, 2020

(30) Foreign Application Priority Data
Mar. 6, 2020 (CN) 202020271563.5

(51) Int. Cl. H02K 37/04; H02K 1/24; H02K 3/52; H02K 7/08

(52) U.S. Cl. CPC H02K 37/04; H02K 1/243; H02K 2203/03; H02K 7/083; H02K 3/524

(57) ABSTRACT

The present disclosure relates to a stepping motor. The stepping motor includes a rotor assembly including a rotating shaft and a magnetic steel sheathed outside the rotating shaft and a number of stator assemblies. The stator assembly spacing is sheathed outside the rotor assembly. The stator assembly includes a fixed claw pole around the periphery of the rotor assembly and a coil on the fixed claw pole. The stator assemblies are arranged in layers along the axial direction of the rotor assembly in turn. Because the plurality of stator assemblies are arranged in the same shaft to drive a rotor assembly together, the problem of easy eccentricity is avoided, and the output efficiency is greatly increased.

### FIELD OF THE PRESENT DISCLOSURE

The present invention relates to the technical field of electrical motors, in particular to a stepping motor.

### DESCRIPTION OF RELATED ART

In the related art, when two motors rotate synchronously, the coaxiality requirement for the two motors is very high, and eccentricity is normally generated, so that the output efficiency of the motors is reduced.

Therefore, it is necessary to provide an integrated-type motor to solve the above technical problems.

### SUMMARY OF THE PRESENT INVENTION

One of the major objects is to provide a stepping motor for solving the problems of easy eccentricity and for increasing the output efficiency.

In order to achieving the object mentioned above, the present invention provides a stepping motor including:

a rotor assembly comprising a shaft and magnets sleeved outside the shaft, along a circumferential direction of the shaft for forming a plurality of first magnetic poles and a plurality of second magnetic poles;

a plurality of stator assemblies sleeved outside the rotor assembly and sequentially stacked and arranged along an axial direction of the rotor assembly, each of the stator assembly comprising a fixed claw pole wound on the periphery of the rotor assembly and a coil sheathed on the fixed claw pole; wherein the fixed claw pole comprises a first claw pole part and a second claw pole part which are oppositely arranged and mutually matched; wherein

the first claw pole part comprises a first base sleeved on the shaft and first pole claws bending and extending from an edge of the base along the axial direction of the shaft towards the second claw pole part, and the first pole claws are distributed at intervals along the circumferential direction of the first base;

the second claw pole part comprises a second base sleeved on the shaft and second pole claws bending and extending from the edge of the base along the axial direction of the shaft towards the first base, and the second pole claws are distributed at intervals along the axial direction of the second base;

the first pole claws and the second pole claws extend in a staggered manner, each first pole claw is positioned between two adjacent second pole claws, and the first pole claw and the second pole claw form a pole claw ring; the coil is sleeved on the periphery of the pole claw ring; and

the polarities of the first pole claw and the second pole claw are opposite, and the polarity of the pole claw ring is set corresponding to the polarity of the magnet.

As an improvement, the stator assembly further comprises a skeleton sleeved on the periphery of the claw pole ring, and the coil is sleeved and fixed on the skeleton.

As an improvement, the first pole claw bends and extends from a side of the first base close to the shaft, the stator assembly further comprises a housing bending and extending from an edge of the first base on a side away from the shaft toward the second base, and the coil is located between the housing and the claw pole ring.

As an improvement, the second pole claw bends and extends from a side of the second base close to the shaft, the stator assembly further comprises a housing bending and extending from an edge of the second base on a side away from the shaft toward the first base, and the coil is located between the housing and the claw pole ring.

As an improvement, the stator assembly further comprises a circuit board fixed outside the housing, and the skeleton extends out as supporting feet in a direction away from the shaft, the housing is provided with an avoiding hole corresponding to the supporting feet, and the supporting feet extend to the outside of the housing through the avoiding hole and are fixedly connected with the circuit board.

As an improvement, the coil is provided with a connection end, and the connection end is wound on the supporting feet and electrically connected with the circuit board.

As an improvement, the first pole claw and the second pole claw are arranged at equal intervals, and widths of the first pole claw and the second pole claw are gradually reduced along respective extending directions.

As an improvement, the stepping motor further comprises end covers respectively sleeved on two ends of the shaft, and the end cover is connected with the shaft through a bearing.

As an improvement, a gasket is arranged between the magnet and each end cover.

As an improvement, a plurality of stator assemblies are divided into at least two different phases, first pole claws or second pole claws of the stator assemblies of the same phase are arranged identically, the coils of the stator assemblies of the same phase are mutually connected in series or in parallel, and the claw pole ring of the stator assemblies of different phases are mutually staggered by a first angle.

As an improvement, the stator assemblies of different phases are staggered in the axial direction of the rotor assembly.

As an improvement, the magnet comprises a plurality of magnet units arranged along the shaft axis, and a single magnet unit corresponds to at least two stator assemblies.

As an improvement, an included angle between adjacent magnetic poles of the magnet and the shaft connecting line is at least twice the first angle.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is an isometric view of a stepping motor according to an embodiment of the present invention;

FIG. 2 is an exploded view of the stepping motor shown in FIG. 1;

FIG. 3 is a cross-sectional view of the stepping motor shown in FIG. 1 taken along line A-A;

FIG. 4 is a partial structural sectional view of the stepping motor shown in FIG. 3;

FIG. 5 is an isometric view of a stator assembly of the stepping motor shown in FIG. 1;

FIG. 6 is an exploded view of the stator assembly of the stepping motor shown in FIG. 5;

FIG. 7 is a cross-sectional view of the stator assembly shown in FIG. 5 taken along line B-B;

FIG. 8 is a schematic diagram of claw pole ring matching of two adjacent stator assemblies of different phases in the stepping motor shown in FIG. 1;

FIG. 9 is a magnetic distribution schematic diagram of a magnet and a pole claw ring of the stator assembly of different phases of the stepping motor according to the embodiment of the present invention;

FIG. 10 is a diagram of the coil current variation of the stator assembly of different phases of the stepping motor according to the embodiment of the present invention;

FIG. 11 is an illustrative diagram of the driving mode of the stepping motor according to the embodiment of the present invention;

FIG. 12 is a two-phase voltage variation diagram of the stepping motor according to the embodiment of the present invention;

FIG. 13 is a schematic diagram of the relationship between the pole claw ring stagger angle of the stator assembly of different phases and the included angle between two adjacent magnetic poles of the magnet and the shaft line in the stepping motor according to the embodiment of the present invention.

### DETAILED DESCRIPTION OF THE EXEMPLARY EMBODIMENT

The present disclosure will hereinafter be described in detail with reference to an exemplary embodiments. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

It should be noted that the terms “first”, “second” and “third” in the description and claims of the present invention and the above-mentioned attached figures are used to distinguish different objects, but not to describe a specific order. Additionally, the term “comprise,” as well as any variations thereof, are intended to cover non-exclusive inclusions. For example, a process, method, system, article of manufacture, or apparatus that comprises a series of steps or elements is not limited to the steps or elements listed, but instead may optionally include steps or unit not listed, or optionally include other steps or elements inherent to such process, method, article of manufacture or apparatus.

All directional indication (such as up, down, left, right, front, back, inside, outside, top, bottom, etc.) in the embodiment of the present invention are only used for explaining the relative position relationship between the components in a specific posture (as shown in the figures), and if the specific posture is changed, the directional indication are correspondingly changed. When an element is referred to as being “fixed” or “provided” on another element, the element may be directly on the other element or an intervening element may be present at the same time. When an element is said to be “connected” to another element, it may be directly connected to the other element or an intervening element may be present at the same time.

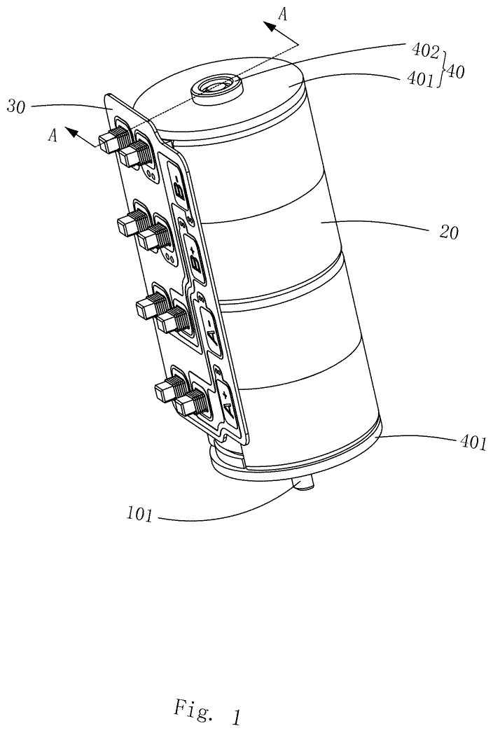

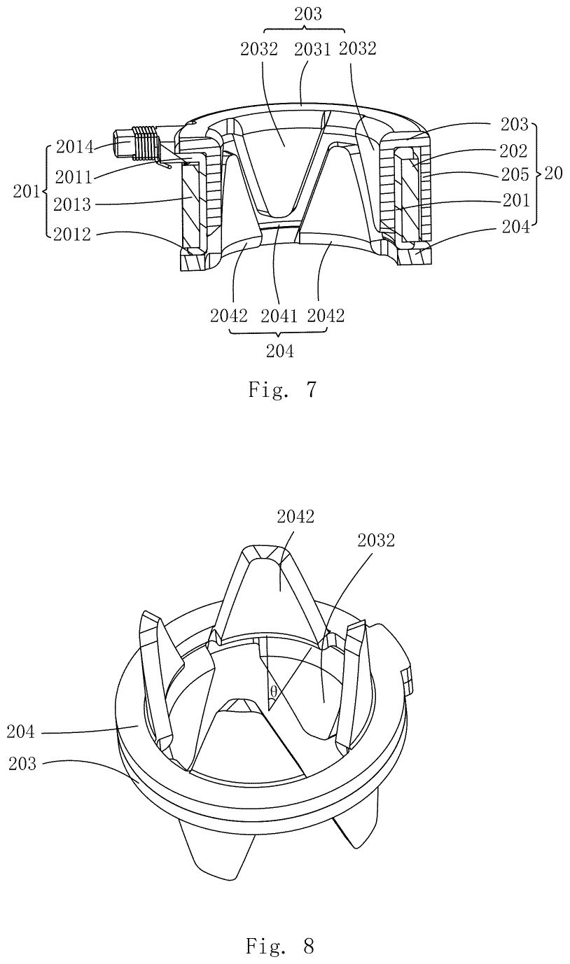

The embodiment of the present invention provides a stepping motor. Referring to FIGS. 1-7, the stepping motor comprises a rotor assembly 10, a stator assembly 20, a circuit board 30 and a support assembly 40.

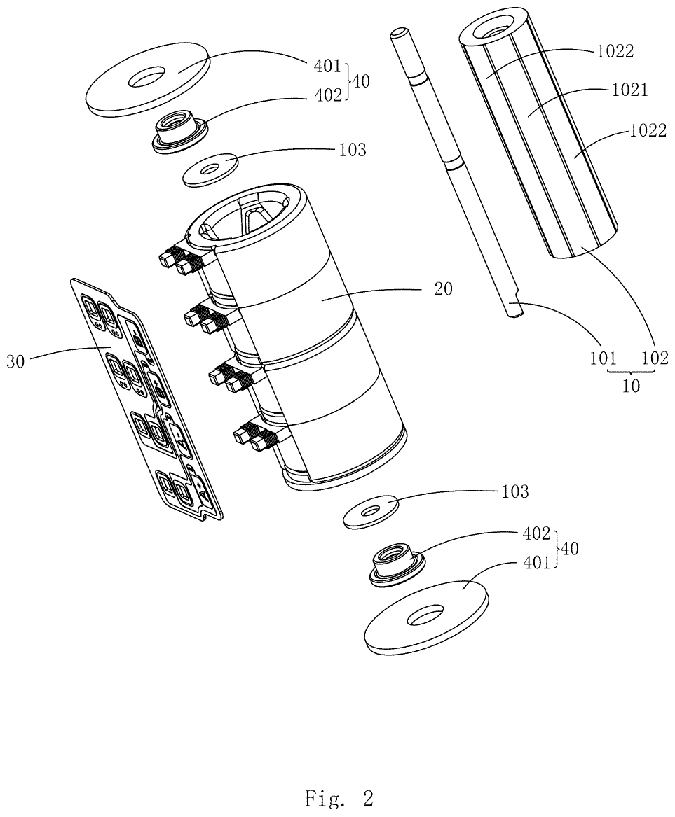

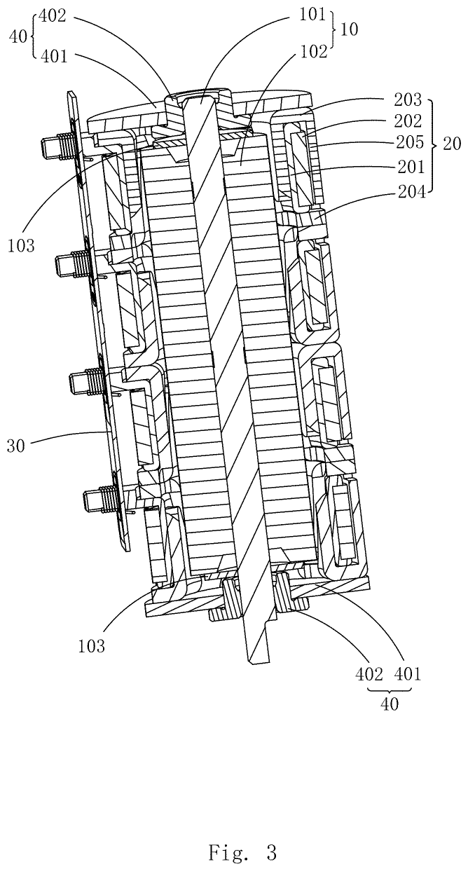

Referring to FIGS. 2 and 3, the rotor assembly 10 comprises a shaft 101 and a magnet 102, the magnet 102 is sleeved outside the shaft 101, and the magnet 102 and the shaft 101 can rotate integrally. The magnet 102 is in a cylindrical shape, and a plurality of first magnetic poles 1021 and a plurality of second magnetic poles 1022 are alternately arranged along the circumferential direction of the shaft 101; the first magnetic pole 1021 and the second magnetic pole 1022 are magnetically opposite, for example, one is an N pole and the other is an S pole.

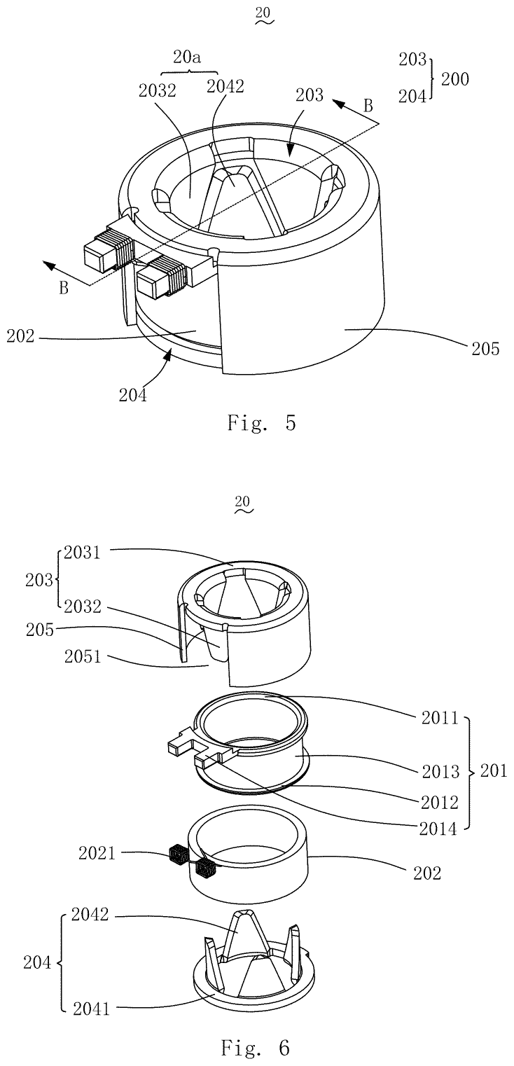

A plurality of stator assemblies 20 are sequentially stacked and arranged along the axial direction of the rotor assembly 10, and each stator assembly 20 is sleeved outside the rotor assembly 10 and is spaced apart from the rotor assembly 10. Specifically, the stator assembly 20 is sleeved outside the magnet 102 at intervals, as shown in FIG. 5, a single stator assembly 20 comprises a fixed claw pole 200 arranged around the rotor assembly 10 and a coil 202 sleeved on the fixed claw pole 200. The fixed claw pole 20 comprises a first claw pole part 203 and a second claw pole part 204 which are oppositely arranged and mutually matched. As shown in FIG. 6, the first claw pole part 203 comprises a first base 2031 sleeved on the shaft 101 and a first pole claw 2032 extending from the edge of the first base 2031 along the axial direction of the shaft 101 toward the second claw pole part 204. The first pole claws 2032 are circumferentially spaced along the first base 2031. The second claw pole part 204 comprises a second base 2041 sleeved on the shaft 101 and a second pole claw 2042 bending and extending from the edge of the second base 2041 along the axial direction of the shaft 101 toward the first base 2031. The second pole claws 2042 are axially spaced along the second base 2041. As shown in FIGS. 5-6, the first pole claw 2032 and the second pole claw 2042 extend alternately, and each first pole claw 2032 is located between two adjacent second pole claws 2042, and the first pole claw 2032 and the second pole claw 2042 enclose a pole claw ring 20a. The coil 201 is sleeved on the periphery of the claw pole ring. The polarities of the first pole claw 2032 and the second pole claw 2042 are opposite, that is, the polarities of the adjacent pole claws of the claw pole ring 20a are opposite, and the polarity of the pole claw ring 20a is set corresponding to the polarity of the magnet 102.

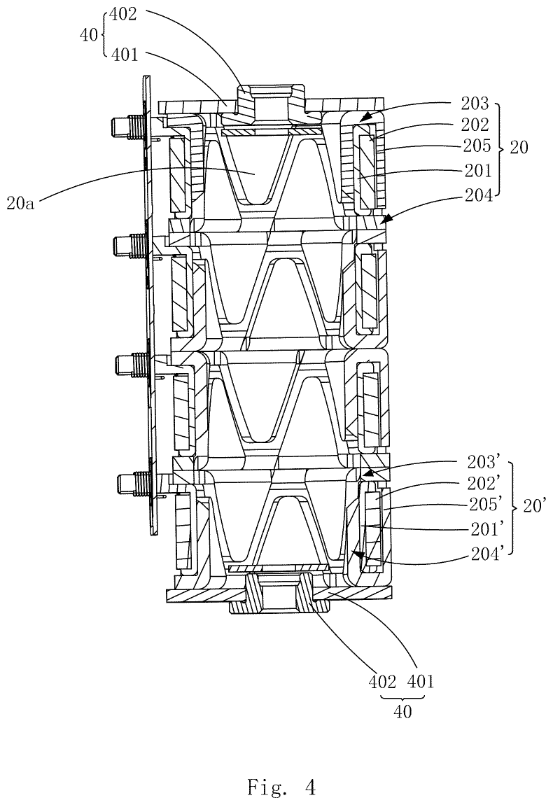

In the preferred embodiment of the present invention, as shown in FIGS. 4-7, in order to further fix the coil 102, the stator assembly 20 further comprises a skeleton 201 sleeved around the claw pole ring 20a. The skeleton 201 comprises a first end 2011 and a second end 2012 which are oppositely arranged, a main cylindrical body 2013 and a supporting feet 2014 , wherein the first end 2011 and the second end 2012 are in a ring shape, a main cylindrical body 2013 connecting an inner periphery of the first end 2011 and an inner periphery of the second end 2012, the supporting feet 2014 being provided at an outer periphery of the first end 2011, the main cylindrical body 2013 having a hollow cavity. The coil 202 is sleeved outside the main cylindrical body 2013, the coil 202 and a connection end 2021 electrically connected outside are fixed to the supporting feet 2014.

Furthermore, in the preferred embodiment of the present invention, the first base 2031 is annular, a plurality of first pole claws 2032 are uniformly distributed on the inner periphery of the first base 2031, and two adjacent first pole claws 2032 are arranged at an interval. When the first claw pole part 203 is fixed to the skeleton 201, the first base 2031 of the first claw pole part 203 abuts against the first end 2011, and a plurality of first pole claws 2032 extend into the hollow cavity of the main cylindrical body 2013 from the first end 2011; the second claw pole part 204 comprises a second base 2041 and a plurality of second pole claws 2042, wherein the plurality of second pole claws 2042 are uniformly distributed on the inner periphery of the second base 2041, and an interval exists between two adjacent second pole claws 2042. When the second claw pole part 204 is fixed on the skeleton 201, the second base 2041 of the second claw pole part 204 abuts against the second end 2012, a plurality of second pole claws 2042 extend from the second end 2012 into the hollow cavity of the main cylindrical body 2013. When the first claw pole part 203 and the second claw pole part 204 match with each other, the plurality of first pole claws 2032 of the first claw pole part 203 and the plurality of second pole claws 2042 of the second claw pole party 204 are interleaved with each other, that is, the second pole claw 2042 is located within the separation region between two adjacent first pole claws 2032, and, the first pole claw 2032 and the second pole claw 2042 are provided corresponding to the first magnetic pole 1021 or the second magnetic pole 1022 of the magnet. For the same stator assembly 20, the first pole claw 2032 and the second pole claw 2042 have opposite magnetic properties, for example, one is an N pole and the other is an S pole.

Further, the first pole claw 2032 and the second pole claw 2042 are equidistantly arranged, and the widths of both the first pole claw 2032 and the second pole claw 2042 gradually decrease along their respective extending directions.

Further, as shown in FIGS. 5-7, the stator assembly 20 further comprises a housing 205 sleeved on the periphery of the coil 201, and the housing 205 can be integrally provided with the first claw pole part 203. The housing 205 may also be provided integrally with the second claw pole part 204 and, in particular, when the housing 205 and the first claw pole part 203 are integrally provided, the housing 205 is sleeved outside the skeleton 201 and the coil 202, the housing 205 extends from the outer periphery of the first base 2031 of the first claw pole part 203 in the axial direction of the stator assembly 20, the housing 205 bends and extends from the edge of the side of the first base 2031 away from the shaft 101 toward the second base 2041, the housing 205 is provided with an avoiding hole 2051 matched with the supporting fee 2014 of the skeleton 201.

When the housing 205 and the second claw pole part 204 are integrally provided, the housing 205 is sleeved outside the skeleton 201 and the coil 202, the housing 205 extends in the axial direction of the stator assembly 20 from the outer periphery of the second base 2041 of the second claw pole part 204. The housing 205 bends and extends from the edge of the side of the second base 2041 away from the shaft 101 toward the first base 2031. The housing 205 is provided with an avoiding hole 2051 matched with the supporting feet 2014 of the skeleton 201. Specifically, as shown in FIG. 4, in an alternative embodiment, in two adjacent stator assemblies 20, the housing 205 of one of the stator assemblies 20 is located on the first claw pole part 203 (such as the first and third stator assemblies from top to bottom in FIG. 4). The housing 205′ of another stator assembly 20′ is located on the second claw pole part 204′ (e.g. the second and fourth and stator assembly from top to bottom in FIG. 4). Other structures of the stator assembly 20′, such as the first claw pole part 203′, the second claw pole part 204′, the coil 202′ and the skeleton 201′ are similar to the corresponding structures of the stator assembly 20 described above.

Preferably, the stator assembly 10 further comprises a circuit board 30 fixed outside the housing 205, the circuit board 30 is fixed with the supporting fee 2014. The connection end 2021 of the coil 202 is wound around the supporting feet 2014. The supporting feet 2014 extends to the outside of the housing 205 through the avoiding hole 2051 and is fixedly connected with the circuit board 30. The connection end 2021 is wound around the supporting feet 2014 and electrically connected to the circuit board 30.

Furthermore, two support assemblies 40 are respectively provided at two ends of the rotor assembly 10, and as shown in FIG. 2, FIG. 3 and FIG. 4, the support assembly 40 comprises an end cover 401 and a bearing 402. The end cover 401 is connected to the shaft 101 via bearing 402, and the shaft 101 can rotate relative to the end cover 401.

Further, the top and the bottom of the magnet 102 are respectively provided with a gasket 103, the gasket 103 is annular and sleeved on the shaft 101, and the gasket 103 is located between the magnet 102 and the bearing 402.

In this embodiment, the plurality of stator assemblies 20 are divided into at least two different phases, and the polarity arrangement of the claw pole ring of the stator assemblies of the same phase is the same. The polarity arrangement of the claw pole ring of the stator assemblies of the different phase has a certain angle difference.

The embodiment of the present invention is schematically illustrated by four stator assemblies 20, and the person skilled in the art should understand that the number of the stator assemblies 20 of the present invention is not limited to this. In an alternative mode of this embodiment, the four stator assemblies 20 are divided into phases a and B, as shown in FIGS. 1 and 2, from bottom to top, A+, A−, B +, and B−, where + and − denote opposite polarities. For another example, in another alternative embodiment of this embodiment, four stator assemblies 20 are divided into A phase and B phase, as shown in FIG. 4, A+, B+, A− and B− are arranged from top to bottom, specifically, the pole claw arrangement of the stator assemblies 20 of the same phase is the same, additionally the coils 202 of the stator assemblies 20 of the same phase are connected in series or in parallel with each other. As shown in FIG. 4, the pole claw arrangement of the stator assembly 20 corresponding to A+ and A− is the same, and the pole claw arrangement of the stator assembly 20 corresponding to B+ and B− is the same. Referring to FIG. 8, the pole claws of the stator assemblies 20 of different phases, B+ and A− respectively, are offset from each other by a first angle θ, specifically. The second pole claw 2042 of the second claw pole part 204 of the stator assembly 20 of B+ and the first pole claw 2032 of the first claw pole part 203 of the stator assembly 20 of A− are offset from each other by a first angle θ. In some alternative embodiments, the first claw pole part 203 comprises N first pole claws 2032, the second claw pole part 204 comprises N second pole claws 2042, the magnetic pole included angle of the adjacent first pole claw 2032 and second pole claw 2042 is 180°/N, and accordingly, N first magnetic poles 1021 and N second magnetic poles 1022 are provided on the magnet 102, and the magnetic pole included angle of the adjacent first magnetic pole 1021 and second magnetic pole 1022 is 180°/N, the first angle θ is ½ of the magnetic pole included angle, that is, the first angle θ is 90°/N, wherein N is a natural number greater than or equal to 2. As shown in FIG. 13, the included angle α between the adjacent first magnetic pole 1021 and the second magnetic pole 1022 of the magnet 102 and the shaft 101 is at least twice of the first angle θ.

In some embodiments of the present embodiment, the same phases may be sequentially arranged, and the four stator assemblies 20 are respectively B−, B+, A−, and A+ from top to bottom, of course, in other embodiments of the present embodiment, the stator assemblies 40 of different phases are staggered in the axial direction of the rotor assembly 10, for example, B−, A−, B+, and A+ from top to bottom. Further, in other embodiments, three phases may be included, for example, A phase, B phase and C phase, from top to bottom, A+, A−, B+, B−, C+ and C−, respectively. Further, in other embodiments, phase A, phase A, phase A, phase B and phase B are from top to bottom.

In some embodiments, the magnet 102 may be provided in segments, the magnet 102 including a plurality of magnet units arranged axially along the shaft 101, a single magnet unit corresponding to at least two of the stator assemblies 20.

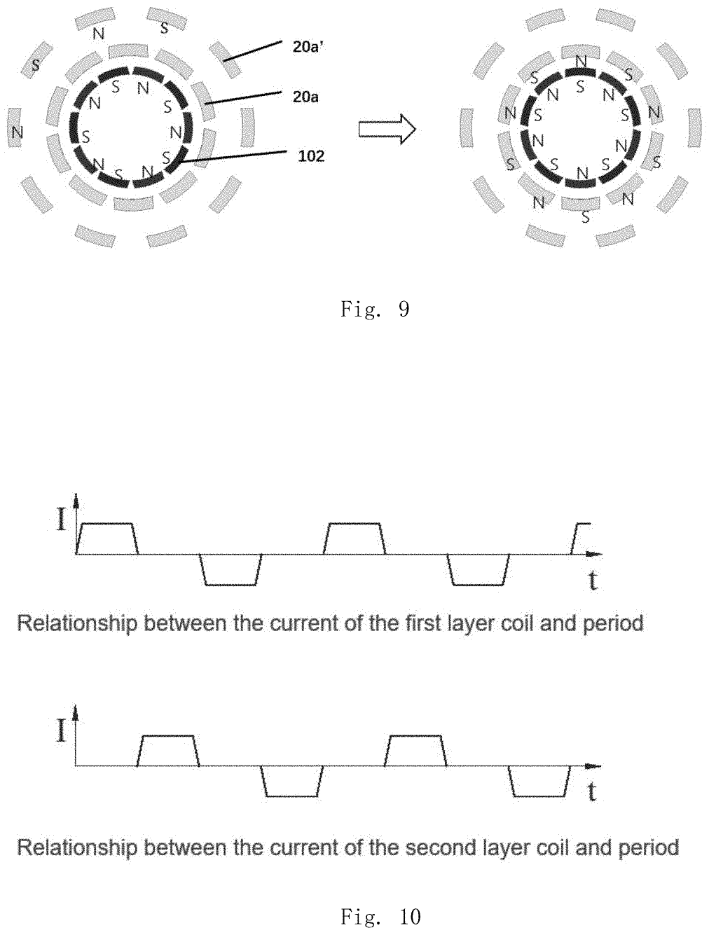

Hereinafter, the input signal and driving mode of the stepping motor of the embodiment are illustrated in a schematic manner. Referring to FIG. 9 and FIG. 10, in order to explain the rotation mode of the stepping motor, in two stator assemblies 20 of different phases, the pole claw ring 20A of one stator assembly is called the first layer pole claw ring, and the coil 202 is called the first layer coil, the pole claw ring 20a′ of the other stator assembly of a different phase is referred to as a second layer pole claw ring and its coil is referred to as a second layer coil. The outer diameter of the second layer pole claw ring 20A′ is enlarged so that it can appear in the same view as the pole claw ring 20 of the first layer. As shown in FIG. 9, the innermost ring is an annular magnet 102, the middle ring is a first layer pole claw ring 20A, and the outermost ring is a second layer pole claw ring 20a′. As shown in FIG. 10, initially, both the first layer coil and the second layer coil are in an off state, a certain current is given to the second layer coil to turn it on, the second layer pole claw ring alternately presents N and S poles under the influence of electromagnetism, two phase current inputs are changed, the pole claw ring of the first layer is in one-to-one correspondence with the N, S and S poles of the magnet. The magnetic field force between the pole claw ring 20A and the magnet 102 pushes the magnet 102 to rotate clockwise.

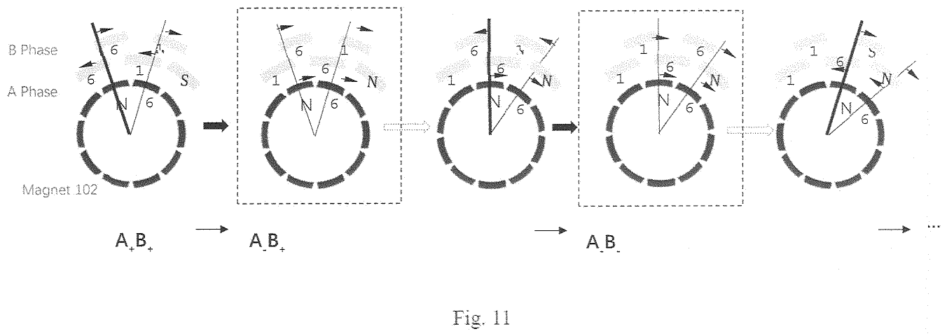

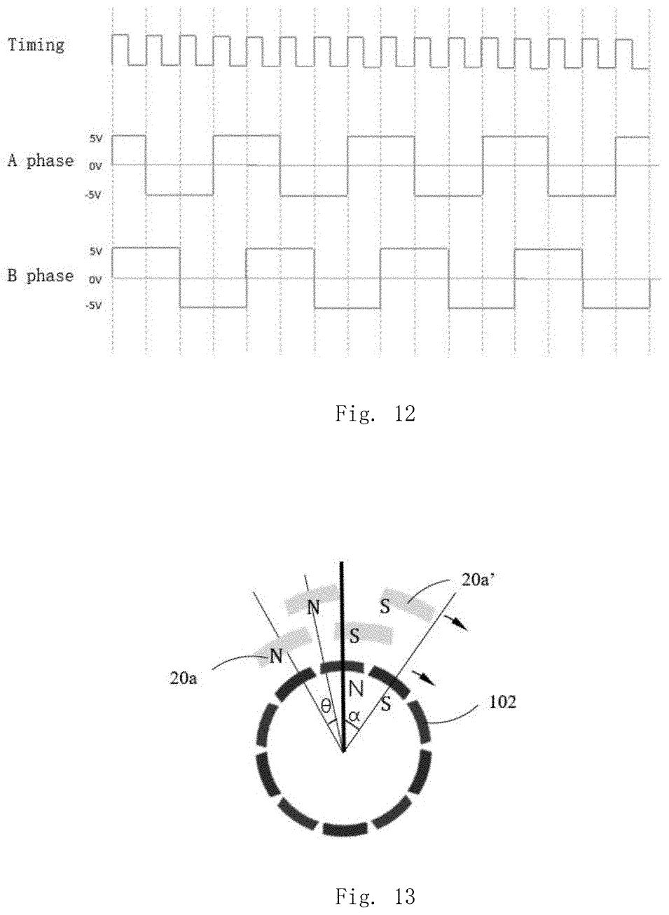

Referring to FIG. 11 and FIG. 12, which are input signals and driving modes of the stepping motor shown in FIG. 1, four stator assemblies 20 respectively represent B−, B+, A− and A+. When the motor rotates forward, the phase change of each stator assembly can be, for example, A+B+→A−B+→A−B−→A+B−→A+B+→ . . . ; when the motor is reversed, the phase change of each stator assembly may be, for example, A+B+→A+B−→A−B−→A−B+→A+B+→ . . .

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A stepping motor comprising:
a rotor assembly comprising a shaft and magnets sleeved outside the shaft, along a circumferential direction of the shaft for forming a plurality of first magnetic poles and a plurality of second magnetic poles;
a plurality of stator assemblies sleeved outside the rotor assembly and sequentially stacked and arranged along an axial direction of the rotor assembly, each of the stator assembly comprising a fixed claw pole wound on the periphery of the rotor assembly and a coil sheathed on the fixed claw pole; wherein the fixed claw pole comprises a first claw pole part and a second claw pole part which are oppositely arranged and mutually matched; wherein
the first claw pole part comprises a first base sleeved on the shaft and first pole claws bending and extending from an edge of the base along the axial direction of the shaft towards the second claw pole part, and the first pole claws are distributed at intervals along the circumferential direction of the first base;
the second claw pole part comprises a second base sleeved on the shaft and second pole claws bending and extending from the edge of the base along the axial direction of the shaft towards the first base, and the second pole claws are distributed at intervals along the axial direction of the second base;
the first pole claws and the second pole claws extend in a staggered manner, each first pole claw is positioned between two adjacent second pole claws, and the first pole claw and the second pole claw form a pole claw ring; the coil is sleeved on the periphery of the pole claw ring; and
the polarities of the first pole claw and the second pole claw are opposite, and the polarity of the pole claw ring is set corresponding to the polarity of the magnet.

2. The stepping motor as described in claim 1, wherein the stator assembly further comprises a skeleton sleeved on the periphery of the claw pole ring, and the coil is sleeved and fixed on the skeleton.

3. The stepping motor as described in claim 2, wherein the first pole claw bends and extends from a side of the first base close to the shaft, the stator assembly further comprises a housing bending and extending from an edge of the first base on a side away from the shaft toward the second base, and the coil is located between the housing and the claw pole ring.

4. The stepping motor as described in claim 2, wherein the second pole claw bends and extends from a side of the second base close to the shaft, the stator assembly further comprises a housing bending and extending from an edge of the second base on a side away from the shaft toward the first base, and the coil is located between the housing and the claw pole ring.

5. The stepping motor as described in claim 3, wherein the stator assembly further comprises a circuit board fixed outside the housing, and the skeleton extends out as supporting feet in a direction away from the shaft, the housing is provided with an avoiding hole corresponding to the supporting feet, and the supporting feet extend to the outside of the housing through the avoiding hole and are fixedly connected with the circuit board.

6. The stepping motor as described in claim 4, wherein the stator assembly further comprises a circuit board fixed outside the housing, and the skeleton extends out as supporting feet in a direction away from the shaft, the housing is provided with an avoiding hole corresponding to the supporting feet, and the supporting feet extend to the outside of the housing through the avoiding hole and are fixedly connected with the circuit board.

7. The stepping motor as described in claim 5, wherein the coil is provided with a connection end, and the connection end is wound on the supporting feet and electrically connected with the circuit board.

8. The stepping motor as described in claim 6, wherein the coil is provided with a connection end, and the connection end is wound on the supporting feet and electrically connected with the circuit board.

9. The stepping motor as described in claim 1, wherein the first pole claw and the second pole claw are arranged at equal intervals, and widths of the first pole claw and the second pole claw are gradually reduced along respective extending directions.

10. The stepping motor as described in claim 1, wherein the stepping motor further comprises end covers respectively sleeved on two ends of the shaft, and the end cover is connected with the shaft through a bearing.

11. The stepping motor as described in claim 9, wherein a gasket is arranged between the magnet and each end cover.

12. The stepping motor as described in claim 1, wherein a plurality of stator assemblies are divided into at least two different phases, first pole claws or second pole claws of the stator assemblies of the same phase are arranged identically, the coils of the stator assemblies of the same phase are mutually connected in series or in parallel, and the claw pole ring of the stator assemblies of different phases are mutually staggered by a first angle.

13. The stepping motor as described in claim 12, wherein the stator assemblies of different phases are staggered in the axial direction of the rotor assembly.

14. The stepping motor as described in claim 1, wherein the magnet comprises a plurality of magnet units arranged along the shaft axis, and a single magnet unit corresponds to at least two stator assemblies.

15. The stepping motor as described in claim 12, wherein an included angle between adjacent magnetic poles of the magnet and the shaft connecting line is at least twice the first angle.
